(19) United States
(12) Patent Application Publication
(10) Pub. No.: US 2024/0181563 A1
(43) Pub. Date: Jun. 6, 2024

(54) DEVICE AND METHOD FOR PROCESSING A WORKPIECE

(71) Applicant: TRUMPF Laser- und Systemtechnik GmbH, Ditzingen (DE)

(72) Inventors: Jonas Kleiner, Leonberg (DE); Daniel Flamm, Ludwigsburg (DE)

(21) Appl. No.: 18/439,786

(22) Filed: Feb. 13, 2024

Related U.S. Application Data
(63) Continuation of application No. PCT/EP2022/072470, filed on Aug. 10, 2022.

(30) Foreign Application Priority Data
Aug. 18, 2021 (DE) 10 2021 121 469.6

(51) Int. Cl. B23K 26/067; B23K 26/0622; B23K 26/24

(52) U.S. Cl. CPC B23K 26/067; B23K 26/0624; B23K 26/24

(57) ABSTRACT

A device for processing a workpiece includes a laser configured to emit a laser beam, a polarization switch configured to switch the polarization of the laser beam between two polarization states and/or to rotate the polarization of the laser beam, a polarization beam splitter configured to split the laser beam into two partial laser beams with mutually orthogonal polarization states. A first partial laser beam has a first offset and a second partial laser beam has a second offset after passing through the polarization beam splitter. The device further includes processing optics configured to introduce the two partial laser beams into the workpiece in two focal zones, in order to process the workpiece. The polarization switch is arranged before the polarization beam splitter in a beam propagation direction. The switching and/or the rotation of the polarization by the polarization switch alternately maximize intensities of the two partial laser beams.

### CROSS REFERENCE TO RELATED APPLICATIONS

This application is a continuation of International Application No. PCT/EP2022/072470 (WO 2023/020916 A1), filed on Aug. 10, 2022, and claims benefit to German Patent Application No. DE 10 2021 121 469.6, filed on Aug. 18, 2021. The aforementioned applications are hereby incorporated by reference herein.

### FIELD

Embodiments of the present invention relate to a device and a method for processing a workpiece with a laser beam of a laser.

### BACKGROUND

In recent years, the development of lasers has led to a new type of material processing. In the case of ultrashort pulse lasers, the short pulse length and high pulse peak power, or the high pulse energy, can lead to nonlinear absorption of the pulse energy in the material of a workpiece, so that materials which are actually transparent, or substantially transparent, for the laser light wavelength used can also be processed.

One particular field of application of such laser radiation is the separation and processing of workpieces. A laser beam is in this case preferably introduced into the material under normal incidence, so that material modifications which deliberately damage the material are generated in the material. This so to speak generates a perforation along which the material can be separated.

A further field of application of such laser radiation is the joining of two joining partners, the respective joining partners being exposed to a laser beam so as to generate a melt in the zone exposed to the laser beam, which forms a weld seam between the joining partners after solidification of the melt. Joining by means of ultrashort laser pulses in this case allows stable connection of the joining partners without the use of additional material.

In the case of both joining and separation, so-called wobbling is known, that is to say a periodic movement of the laser beam around a joining or separating line. In this way, high-quality edges are generated in the separation or joining seams in the joining.

To date, the processing optics or a part of the processing optics need to be moved periodically for such a wobble movement, which results in a complicated structure of the processing optics and elaborate adjustment of the processing optics.

### SUMMARY

Embodiments of the present invention provide a device for processing a workpiece with a laser beam. The device includes a laser configured to emit the laser beam, a polarization switch configured to switch the polarization of the laser beam between two polarization states and/or to rotate the polarization of the laser beam, a polarization beam splitter configured to split the laser beam into a first partial laser beam and a second partial laser beam. The first partial laser beam has a first polarization state. The second partial laser beam has a second polarization state orthogonal to the first polarization state. The first partial laser beam has a first offset after passing through the polarization beam splitter, and the second partial laser beam has a second offset after passing through the polarization beam splitter. The device further includes processing optics configured to introduce the first partial laser beam into the workpiece in a first focal zone and the second partial laser beam into the workpiece in a second focal zone, in order to process the workpiece. The polarization switch is arranged before the polarization beam splitter in a beam propagation direction. The switching and/or the rotation of the polarization by the polarization switch alternately maximize intensities of the first partial laser beam and the second partial laser beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of the device according to some embodiments;

FIGS. 2A, B, C, D show a schematic representation of a polarization beam splitter and the interaction with a polarization switch, according to some embodiments;

FIGS. 3A, B show a schematic representation of the polarization-based wobble movement, according to some embodiments;

FIGS. 4A, B, C, D, E show further schematic representations of the devices, according to some embodiments;

FIGS. 5A, B, C show a schematic representation of a beamforming element and generation of a multi-spot profile, according to some embodiments;

FIGS. 6A, B show a further schematic representation of the device, according to some embodiments;

FIG. 7 shows a further schematic representation of the device and of the method according to some embodiments; and

FIG. 8 shows a further schematic representation of the device and of the method according to some embodiments.

### DETAILED DESCRIPTION

Embodiments of the present invention provide an improved device for processing a workpiece, as well as a corresponding method.

Correspondingly, a device for processing a workpiece with a laser beam of a laser is proposed, comprising a laser, which is adapted to emit a laser beam, a polarization switch, which is adapted to switch the polarization of the laser beam between two polarization states and/or to rotate the polarization of the laser beam, a polarization beam splitter, which is adapted to split the laser beam into two partial laser beams, the two partial laser beams having mutually orthogonal polarizations, the first partial laser beam with the first polarization having a first offset after passing through the polarization beam splitter and the second partial laser beam of a second polarization having a second offset after passing through the polarization beam splitter, and processing optics, which are adapted to introduce the first partial laser beam into the workpiece in a first focal zone and the second partial laser beam into the workpiece in a second focal zone, in order to process the workpiece. According to embodiments of the invention, the polarization switch is arranged before the polarization beam splitter in the beam propagation direction, the switching and/or rotation of the polarization by the polarization switch alternately maximizing the intensities of the two partial laser beams.

A polarization switch makes it possible to modify the polarization of an incident laser beam provided by the laser. A modification may consist in generating a laser beam in a final polarization state from a laser beam in an initial polarization state. For example, a laser beam in a p-polarization state, the polarization of which is parallel to the incidence plane, may be generated from a laser beam in an s-polarization state, the polarization of which is perpendicular to the incidence plane of the laser beam.

This may be done by rotating the polarization of the laser beam continuously from the initial polarization state into the final polarization state, so that a laser beam in a final polarization state is generated. In the course of time, the laser beam therefore assumes all polarization states between the initial polarization state and the final polarization state.

It may, however, also be that the polarization of the laser beam is switched. In that case, the laser beam assumes only two polarization states in the course of time, namely the initial polarization state and the final polarization state, that is to say for example an s-polarization state and a p-polarization state.

It may, however, also be that the polarization of the laser beam is switched to intermediate polarization states lying between the initial polarization state and the final polarization state. For example, the laser beam may also be switched between an s-polarization state and a p-polarization state to an intermediate polarization state in which the polarization is at an angle not equal to 0° or 90°, for example 30° or 45° or 60°, with respect to the incidence plane.

The above description of the polarization switch applies similarly for circularly or elliptically polarized laser beams. In this case, an initial polarization state may consist of a polarization state of a first handedness, for example left-handedness, and the final polarization state may consist of a polarization state of a second handedness, for example right-handedness. The intermediate polarization state may in this case, for example, be a linear polarization state or an elliptical polarization state.

A polarization beam splitter makes it possible to resolve an incident laser beam into linear basis polarization states and to spatially separate the respective basis polarization states in the form of partial laser beams. In this case, the polarization of the incident laser beam is projected onto the basis polarization states of the polarization beam splitter. Such polarization beam splitters are typically based on a birefringence of the laser beam in the polarization beam splitter.

Birefringence means the ability of an optical material to separate the incident laser beam into two partial laser beams polarized perpendicularly to one another. This occurs because of different refractive indices of the optical material as a function of the polarization and the angle of incidence of the light relative to the optical axis of the optical material. The separation of the arbitrarily polarized laser beam therefore takes place into the basis polarization states of the polarization beam splitter because of the shape and configuration of the optical axis of the optical material of the polarization beam splitter.

In the context of this application, partial laser beams polarized perpendicularly to one another mean linearly polarized partial laser beams, the polarization directions of which are aligned at an angle of 90° with respect to one another. Partial laser beams polarized perpendicularly to one another also mean, however, circularly polarized partial laser beams having opposite senses of rotation, i.e. two left or right circularly polarized partial laser beams. The conversion from linearly polarized partial laser beams having polarization directions aligned perpendicularly to one another into circularly polarized partial laser beams having opposite senses of rotation may, for example, be carried out with a suitably oriented retardation plate (λ/4 plate), see below.

The partial laser beams, resolved according to basis polarization states, which emerge from the polarization beam splitter may have an angle offset and/or a position offset with respect to one another. This may also be attributed to the anisotropy of the refractive indices for different polarization directions of the optical material of the polarization beam splitter.

For example, the partial laser beams may have an angle offset after passing through the polarization beam splitter. This means that the first partial laser beam having a first polarization does not travel parallel to the second partial laser beam having a second polarization behind the polarization beam splitter.

In order to generate the angle offset (without a position offset), the polarization beam splitter may have a beam exit face which is inclined at an angle with respect to the beam entry face. The optical axis of the birefringent crystal is in this case typically aligned parallel to the beam entry face. The two partial laser beams in this case emerge on the beam exit face at the same position and with a defined angle offset from the birefringent crystal.

For example, the partial laser beams may have a position offset after passing through the polarization beam splitter. This means that the partial laser beam having the first polarization travels parallel to the partial laser beam having the second polarization behind the birefringent polarization element. The two partial laser beams are displaced parallel to one another, however, so that there is a finite spacing between the two partial laser beams.

In order to generate the position offset (without an angle offset), the polarization beam splitter may for example have parallel, generally plane, beam entry and exit faces. The optical axis of the birefringent crystal is in this case typically aligned at an angle with respect to the beam entry face. If the laser beam strikes the beam entry face perpendicularly, a pure position offset is generated at the beam exit face.

The spacings of the individual partial laser beams having different polarizations may be established by the polarization beam splitter, for example during production or by orientation of the optical axis of the crystal with respect to the incident laser beam.

For example, a polarization beam splitter may not deviate a first partial laser beam and may deviate a second partial laser beam. Accordingly, the first partial laser beam would continue to propagate on the optical axis, although the second partial laser beam would not. It is also possible for the two partial laser beams to be deviated in opposite directions. It is also possible for the two partial laser beams to be deviated in the same direction but to different extents.

In particular, the first offset (or the second offset) may also be zero and only the second offset (or the first offset) may assume a finite value, since this already allows splitting into partial laser beams.

The processing optics make it possible to convey the partial laser beams of different polarizations, which are provided by the polarization beam splitter, into two different focal zones and introduce them into the workpiece. In particular, a first partial laser beam of a first polarization is introduced into the workpiece in a first focal zone and the second partial laser beam of a second polarization is introduced into the workpiece in the second focal zone, in order to process the workpiece.

In particular, the focal zones may lie in the same focal plane or in different focal planes. This may mean that the first focal zone lies, for example, before or behind the second focal zone in the beam propagation direction. The two focal zones may also lie in the same focal plane, the focal zones being however offset with respect to one another in the focal plane. For example, one focal zone may lie below the interface during the joining and the other focal zone may lie above the interface during the joining.

Processing may, for example, include in a workpiece being separated, or an edge being chamfered, or a premade break point being generated, or a directed material stress being generated, and so on. It may, however, also be that the workpiece comprises two joining partners which are intended to be joined together. A number of variants of the processing will be discussed below.

The polarization switch is arranged before the polarization beam splitter in the beam propagation direction. The polarization beam splitter in this case performs fixed splitting and/or deviation of the laser beam into its orthogonal basis polarization components. This means that the extent of the spatial splitting of the two partial laser beams is independent of the polarization of the incident laser beam. It however also means that the first partial laser beam is in a first basis polarization state of the polarization beam splitter and propagates along a first path through and out of the polarization beam splitter, and the second partial laser beam is in a second basis polarization state and propagates along a second path through and out of the polarization beam splitter.

By the polarization switch being arranged before the polarization beam splitter, the polarization of the incident laser beam can be manipulated so that the polarization state of the incident laser beam corresponds to a basis polarization state of the polarization beam splitter. Then—with full polarization of the incident laser beam, the entire laser energy of the laser beam is transported along the path of the partial laser beam of the selected basis polarization state.

For example, the polarization beam splitter may deviate a laser beam into a first partial laser beam in a first basis polarization state and a second partial laser beam in a second basis polarization state. If the laser beam is already fully in the first basis polarization state before the polarization beam splitter, the laser beam is deviated onto the path of the first partial laser beam. Splitting of the laser beam does not take place because of the full polarization of the incident laser beam.

If the laser beam is switched back and forth with the polarization switch between the two basis polarization states, the laser beam is alternately deviated onto the path of the first and the second partial laser beam. Accordingly, the laser energy is introduced alternately into the first focal zone or the second focal zone.

If the laser beam is switched back and forth with the polarization switch between the two basis polarization states, the laser beam is alternately deviated onto the path of the first and the second partial laser beam, although splitting of the laser beam is also carried out in each intermediate polarization state of the laser beam. Accordingly, the laser power is introduced initially into a first focal zone, then partly into the first focal zone and partly into the second focal zone, and finally into the second focal zone. The proportions of the laser energy (or intensity) introduced into the first and the second focal zone are in this case dictated by the projection of the polarization of the incident laser beam onto the basis polarization states of the polarization beam splitter.

In particular, the intensity of the two partial beams is thus maximised, or the energy introduced into the two different focal zones is maximised, alternately by the selection of the polarization state by the polarization switch.

The alternate introduction of the laser energy into the focal zones may in this case mean a behavior which is periodic at least in sections as a function of time. In this way, it is possible in particular to imitate a wobble movement of the laser beams. The wobble amplitude is in this case defined by the spatial separation of the focal zones. In addition, the wobble frequency, that is to say the temporal repetition rate of the alternating introduction of the laser energy into the focal zones, may be adjusted by the polarization switch.

The maximization of the intensity of the partial laser beams may in this case mean that the processing of the workpiece with the device is possible even with incompletely polarized laser light. If the incident laser beam is only 80% polarized, for example, only 80% of the laser beam may be deliberately split and/or deviated by the polarization beam splitter.

The device according to embodiments of the invention has the advantage that the position of the laser beam is not modified by a movement of the processing optics, so that the device has a high mechanical stability. In particular, the position change takes place at a location other than in the processing optics, so that the processing optics may be produced simply. This allows a simple structure of the device as well as economical implementation, and power-compatible elements may be employed simply. Furthermore, processing optics having a large aperture may be used, as well as with fast process speeds.

Preferably, the polarization beam splitter is configured as a birefringent polarization beam splitter in the form of a birefringent crystal. In this way, beam guiding of the laser beam inside the device may be simplified and work for adjusting the laser beam in conjunction with the polarization beam splitter may be reduced.

The wavelength of the laser beam may be between 200 nm and 2000 nm, preferably 257 nm or 343 nm or 515 nm or 1030 nm.

The device is therefore suitable for processing a workpiece independently of the wavelength. In particular, an appropriate laser wavelength may be selected for the workpiece and the processing to be achieved, so that optimal processing may result. Depending on the specific wavelength, however, it may in this case be necessary to adapt the optical elements of the device correspondingly to the wavelength of the laser beam.

The laser may be a continuous-wave laser or a pulsed laser, in particular an ultrashort pulse laser, and/or a single-mode or multimode laser and/or fiber-guided or free-space-guided.

A continuous-wave laser provides a continuous laser beam, so that laser energy is transported continuously along the laser beam.

In contrast thereto, the pulsed laser provides laser energy only during particular time intervals, the length of which is the so-called pulse length. The energy transport by the laser pulses likewise takes place along the laser beam in this case. In particular, a pulsed laser may also be an ultrashort pulse laser, in which case the pulse duration of the laser pulses may be less than 10 ps, preferably less than 1 ps.

Instead of individual laser pulses, the laser may also provide bursts, each burst comprising the emission of a plurality of laser pulses. For a particular time interval, the emissions of the laser pulses may in this case follow one another very closely, with a spacing of from a few picoseconds to hundreds of nanoseconds. The bursts may be in particular so-called GHz bursts, in which the sequence of the successive laser pulses of the respective burst takes place in the GHz range.

In this context, a sequence of individual pulses means that a plurality of individual pulses are emitted successively by the laser. A sequence of individual pulses therefore comprises at least two individual pulses. A sequence of bursts means that a plurality of bursts are respectively emitted successively by the laser. A sequence of bursts therefore comprises at least two bursts. In particular, the bursts or individual pulses of the sequence may respectively be identical. The bursts or individual pulses are identical if the laser pulses used have substantially the same properties, that is to say approximately the same pulse energy, the same pulse length and—in the case of bursts—also the same pulse spacings within the burst.

In order to process the material, individual pulses and/or bursts may be introduced into the material and, for example, absorbed successively. This multiplicity of ultrashort individual pulses and/or bursts introduced at one position is also referred to as a laser spot, the number N of individual pulses and/or bursts per laser spot being given by the product of the spot size SG and the repetition rate P divided by the feed rate VG: N=SG*P/VG. The spot size in this case describes the spatial region over which the ultrashort laser pulses and/or bursts are emitted into the material.

The size of the processing region is in this case additionally determined by the beam geometry, in particular the size of the focal zone of the focused laser beam. The beam geometry in this case describes the spatial configuration of the laser beam as well as further beam properties, for example particular diffraction properties of the laser beam, see below.

Owing to its design, the resonator length of the laser may give rise to a multiplicity of longitudinal modes in the laser beam. Such a laser is also referred to as a multimode laser. If only a single mode is provided by the laser, the term single-mode laser is used. According to embodiments of the present invention, both single-mode and multimode lasers may be used.

With a fiber-guided laser, the laser beam of the laser is coupled into a fiber and thus guided to the place of use, or to the optical elements of the device. Such a fiber may for example be an optical fiber, a glass fiber or a hollow-core fiber. In free beam guiding, the laser beam is guided via an optical lens and/or mirror system to the optical elements of the device, or to the processing optics. While in the first case flexible laser guiding may easily be implemented, for example also in a curve or from space-to-space, in the second case the laser beam can be manipulated simply since the laser beam is freely accessible.

The degree of polarization of the laser beam before the polarization switch may be more than 50%.

It is thereby possible that the polarization switch can manipulate the polarization of the laser beam well. If the laser beam were unpolarized, the polarization switch could not modify any polarization. The higher the degree of polarization is, the higher the contrast of the two partial laser beams is in the two focal zones.

For example, a polarization filter may be arranged before the polarization switch in order to polarize the laser beam, or increase the degree of polarization.

The laser may comprise the polarization switch.

A simple structure of the device may thereby be achieved if the laser already has a laser beam with a controlled, or switchable and/or rotatable, polarization.

The polarization switch may be a Pockels cell and/or a rotating 24 plate and/or a rotating λ/2 plate.

A Pockels cell is an optoelectronic device which can modify the polarization of a laser beam passing through the Pockels cell by application of a control voltage. In particular, it is possible to rotate the polarization of the laser beam and/or convert a linear (elliptical or circular) polarization into an elliptical or circular (linear) polarization. Accordingly, switching or rotation or modification of the polarization may be carried out easily by the voltage control.

For example, a sinusoidal voltage may be applied to the Pockels cell so that the energy deposited in each focal zone, or the intensity of the two partial laser beams, is modulated sinusoidally. It is, however, also possible for the voltage to have another curve shape, for example being rectangular or sawtoothed. In particular, the polarization may thereby be switched.

In particular a Pockels cell may obviate moving parts in the device, so that particular mechanical stability may be achieved.

A rotating λ/2 plate rotates the polarization of the laser beam proportionally to the rotation angle of the λ/2 plate about the optical axis of the optical crystal used. For example, the λ/2 plate may also be segmented, a first segment having a first optical axis and a second segment having a second optical axis. At the transition of the laser beam from one segment into another segment, a discontinuity of the polarization rotation of the laser beam can be generated because of the rotation. In particular, switching of the polarization may thereby also be achieved with a rotating λ/2 plate.

A rotating 24 plate generates a left or right circularly polarized laser beam from an incident linearly polarized laser beam in a periodic manner corresponding to the rotation. By a subsequent λ/4 plate, the circularly polarized laser beam may be converted back into a linearly polarized laser beam, all linear polarization states being passed through as in the case of the rotating λ/2 plate. For an incident circularly polarized laser beam, only one rotating λ/4 plate is sufficient in order to generate a rotating linear polarization.

A λ/4 plate may be arranged before the polarization beam splitter in the beam propagation direction and be adapted to convert a circularly polarized laser beam into a linearly polarized laser beam.

In particular, circularly polarized light of the polarization switch may in this way be converted into linearly polarized light so that a projection of the polarization state onto the basis polarization states of the polarization beam splitter leads to a modulation of the intensity of the partial laser beams in the focal zones.

As already described further above, the two partial laser beams may be mutually orthogonally linearly polarized, preferably p- and s-polarized, behind the polarization beam splitter in the beam propagation direction. It is, however, also possible for the mutually orthogonally linearly polarized partial laser beams to be converted into mutually orthogonally circularly polarized partial laser beams by a λ/4 plate which is arranged behind the polarization beam splitter in the beam propagation direction.

It is also possible for a Pockels cell and a λ/4 plate to be combined as a polarization switch. The polarization of the laser beam may for example be switched by +λ/4 with the Pockels cell, so that a rotation of the polarization is achieved in combination with the λ/4 plate, which may be arranged before or after the Pockels cell.

Overall, it is thereby possible to determine the polarization direction as well as the handedness of the polarization. Ideal adaptation of the polarization to the processing of the workpiece is therefore possible.

The processing optics may comprise a collimation lens and a focusing lens.

The collimation lens is in this case adapted to convert ray bundles of nonparallel partial beams, in particular divergent partial beams, into parallel partial beams. In particular, the partial laser beams of the polarization beam splitter may be parallelized with an angle offset by a collimation lens.

The focusing lens may convey the partial beams of a ray bundle into a focal zone. In particular, it is thereby possible to convey two different ray bundles, such as those of the partial laser beams which are provided by the polarization beam splitter, into two different focal zones.

Only by the focusing, and the convergence due to this of the ray bundles of the partial laser beams, into the respective focal zone is an intensity increase by which the workpiece can be processed achieved in the focal zone.

The processing optics may comprise a beamforming element, preferably a diffractive optical element or a microlens array, which is adapted to convert a first intensity distribution of the laser beam into a second intensity distribution of the laser beam.

A diffractive optical element is adapted to influence the incident laser beam in respect of one or more properties in two spatial dimensions. A diffractive optical element is a fixed component which, for example, may be used to produce a particular nondiffractive laser beam from the incident laser beam. A diffractive optical element may also be suitable for splitting an incident laser beam into a plurality of partial laser beams. Typically, a diffractive optical element is a specially designed diffraction grating, the incident laser beam being brought into the desired beam shape by the diffraction.

A microlens array is an arrangement of a multiplicity of lenses, each of which generates its own image of the partial laser beams. With a microlens array, the two partial laser beams of the polarization beam splitter may be split into a multiplicity of partial laser beams.

The beamforming element may be adapted to impart a Gaussian beam profile or a nondiffractive beam profile or a flat-top beam profile to the laser beam.

In particular, nondiffractive beams and/or Bessel-like beams mean beams in which a transverse intensity distribution is propagation-invariant. In particular, in the case of nondiffractive beams and/or Bessel-like beams, a transverse intensity distribution is substantially constant along the direction of beam propagation.

In respect of the definition and properties of nondiffractive beams, reference is made to the book: “Structured Light Fields: Applications in Optical Trapping, Manipulation and Organization”, M. Wördemann, Springer Science & Business Media (2012), ISBN 978-3-642-29322-1. Full explicit reference is made thereto.

Accordingly, nondiffractive laser beams have the advantage that they can have a focal zone which is elongated in the beam propagation direction and is significantly larger than the transverse dimensions of the focal zone. For example, a material modification which is elongated in the beam propagation direction may thereby be generated.

It is, however, also possible for the beamforming device to introduce the various partial laser beams into differently deep focal zones in the beam propagation direction.

A flat-top beam profile corresponds to a homogeneous and sharply delimited beam cross section, there being an equally high intensity everywhere in the homogeneous part of the beam cross section, although the intensity decreases rapidly to an almost vanishing value because of the sharp delimitation.

A Gaussian beam profile has a Gaussian bell curve as its beam cross section.

The second intensity distribution due to the beamforming element may be a multi-spot distribution, each individual spot of the multi-spot distribution having a Gaussian beam profile or a nondiffractive beam profile or a flat-top beam profile.

In this case, for example, the number of partial laser beams may be established by means of the beamforming element. This gives rise to a so-called multi-spot distribution, which is composed of different individual spots. In particular, the beamforming element may establish whether the split partial laser beams lie on a one-dimensional line or a two-dimensional grid.

The splitting may in this case be brought about independently of the polarization of the laser beam. In particular, the polarization of the laser beam is maintained when passing through the beamforming element. However, possible position deviations or angle offsets from the optical axis are taken into account when passing through the beamforming element, so that the beamforming element brings about splitting and deviation in addition to previous splitting and deviation.

For example, a first partial laser beam may be a Gaussian laser beam, a second partial laser beam may be a flat-top beam and a third partial laser beam may be a nondiffractive beam. It is, however, also possible for all the partial laser beams to be for example Gaussian laser beams.

It is also possible for a two-dimensional multi-spot distribution, consisting for example of 4×4 multi-spots, to be generated by the beamforming optics. The polarization of the neighboring multi-spots may in this case be different. It may, however, also be that the polarization is the same in rows or columns. It is, however, also possible to generate a linear, for example 6×1 multi-spot distribution, the spots having an alternating polarization.

The workpiece may be separated along a separating line by the processing.

The material modifications introduced into transparent materials by ultrashort laser pulses are subdivided into three different classes; see K. Itoh et al. “Ultrafast Processes for Bulk Modification of Transparent Materials” MRS Bulletin, vol. 31, p. 620 (2006): Type I is an isotropic refractive index change; type II is a birefringent refractive index change; and type III is a so-called void. The material modification generated depends in this case on laser parameters such as the pulse duration, the wavelength, the pulse energy and the repetition frequency of the laser, on the material properties, inter alia the electronic structure and the coefficient of thermal expansion, and on the numerical aperture (NA) of the imaging optics.

Type I isotropic refractive index changes are attributed to locally limited melting by the laser pulses and rapid resolidification of the transparent material of the workpiece. In the case of quartz glass, for example, the density and the refractive index of the material are higher if the quartz glass is cooled rapidly from an elevated temperature. Thus, if the material in the focal volume melts and then cools rapidly, the quartz glass has a higher refractive index in the regions of the material modification than in the unmodified regions.

Type II birefringent refractive index changes may, for example, result from interferences between the ultrashort laser pulse and the electric field of the plasma generated by the laser pulses. This interference leads to periodic modulations in the electron plasma density, which upon solidification leads to a birefringent property, that is to say direction-dependent refractive indices, of the transparent material. A type II modification is also associated, for example, with the formation of so-called nanogratings.

The voids of type III modifications may, for example, be generated with a high laser pulse energy. The formation of the voids is in this case attributed to an explosive expansion of highly excited vaporized material from the focal volume into the surrounding material. This process is also referred to as microexplosion. Since this expansion takes place inside the mass of the material, the microexplosion leaves behind a less dense or hollow core (the void), or a microscopic defect in the submicrometre range or in the atomic range, which is surrounded by a compacted material shell. The compaction at the shock front of the microexplosion creates stresses in the transparent material, which may lead to spontaneous crack formation or may promote crack formation.

In particular, the formation of voids may also be associated with type I and type II modifications. For example, type I and type II modifications may occur in the less stressed areas around the laser pulses which are introduced. Accordingly, whenever the introduction of a type III modification is referred to, a less dense or hollow core, or a defect, is present. For example, in the case of a type III modification in sapphire, a region of lower density rather than a void is generated by the microexplosion. Because of the material stresses occurring in the case of a type III modification, such a modification is also often associated with, or at least promotes, crack formation. The formation of type I and type II modifications cannot be fully prevented or avoided when introducing type III modifications. “Pure” type III modifications are therefore not likely to be encountered.

With the device, it is however also possible to process, in particular to cut, opaque materials, for example metals or sheet metal. In this case, material is vaporized and ablated by the high-energy excitation of the material of the workpiece.

For sheet-metal cutting with a pulsed laser, the typical spot size is between 50 μm and 500 μm, preferably 150 μm, and the typical seam width is between 50 μm and 500 μm, preferably 200 μm. The so-called wobble amplitude, that is to say the spatial separation of the focal zones, which is generated by the polarization beam splitter and the processing optics, is between 100 μm and 4000 μm, typically 600 μm.

In addition, the wobble frequency during sheet-metal cutting is typically less than 5 kHz, preferably between 200 Hz and 2000 Hz.

The workpiece may comprise two joining partners, which are joined together by the processing.

The joining partners may in this case be arranged on one another so that the interfaces of the joining partners, over which the joining partners are intended to be joined together, face towards one another. The abutting face is in this case the face at which the joining partners bear on one another.

Successive absorption of the laser beam, preferably of the ultrashort laser pulses, takes place in the joining region, and heat therefore accumulates if the energy input of the laser beam is greater than the rate of thermal dissipation by material-specific thermal transport mechanisms, in particular by thermal diffusion. The melting temperature of the material of the joining partners may thus finally be reached by the increasing temperature in the material of the at least first joining partner, which leads to local melting of the material of the joining partners.

The joining region accordingly refers to the region of the joining partners in which the material is melted. Alternatively, the material locally melted in the joining region may be referred to overall as a melt pool. Regardless of the terminology, the resulting melt can bridge the entire interface of the joining partners and permanently connect the joining partners to one another upon cooling. In this case, in particular, the network structure of the joining partners may be modified. The cooled melt which connects the joining partners to one another, or the join, is then referred to as a joining seam.

In the case of joining with a pulsed laser, the seam width is typically between 10 μm and 500 μm, preferably 50 μm, for a beam diameter of 2 μm. The region affected by an individual spot is in this case significantly larger than the beam diameter since a region which exceeds the spatial extents of the individual spot is melted because of the accumulation of heat and thermal transport. The wobble amplitude is between 1 μm and 1000 μm, typically 200 μm.

In addition, the wobble frequency during sheet-metal cutting is typically less than 5 kHz, preferably between 200 Hz and 2000 Hz.

The device may have a feed device, which is adapted to move the workpiece and the laser beam relative to one another with a feed along a trajectory, the feed preferably taking place perpendicularly or parallel to the splitting of the laser beam.

The trajectory in this case describes the line of incidence of the laser beam if no splitting is generated by the polarization beam splitter or a beamforming element. By a feed, the laser beam and the workpiece are displaced relative to one another with a feed rate, for example, which with increasing time gives rise to different points of incidence of the undeviated laser beam on the surface of the workpiece.

The wobble movement is superimposed on this trajectory, so that processing of the material takes place around the trajectory.

The device may have a scanner unit, which is adapted to scan the partial laser beams over the workpiece, the scanner unit preferably being a galvanometer scanner.

In particular, a galvanometer scanner allows accurate and rapid positioning of the laser field over the workpiece.

The polarization switch may be arranged before or after the fiber guiding or free-space guiding and/or before or after the collimation lens, and the polarization beam splitter may be arranged after the collimation optics and after the polarization switch and before the focusing optics or before the collimation optics and after the polarization switch.

The polarization switch may, for example, be arranged after the fiber guiding or free-space guiding and arranged after the collimation lens, and the polarization beam splitter may be arranged after the collimation optics and before the focusing optics.

The polarization switch may, for example, be arranged after the fiber guiding or free-space guiding and arranged before the collimation lens, and the polarization beam splitter may be arranged after the collimation optics and before the focusing optics.

The polarization switch may, for example, be arranged before the fiber guiding or free-space guiding and therefore arranged before the collimation lens, and the polarization beam splitter may be arranged after the collimation optics and before the focusing optics.

In the examples mentioned above, the polarization beam splitter may also be arranged after or before the collimation optics and after the polarization switch.

Preferably, a polarization beam splitter which generates an angle offset of the partial laser beams is arranged before the collimation optics, while a polarization beam splitter which generates only an offset of the partial laser beams may be arranged behind the collimation optics and before the focusing optics.

The object stated above is furthermore achieved by a method for processing a material having the features of claim 20. Advantageous developments of the method may be found in the dependent claims, the present description and the figures.

Correspondingly, a method for processing a workpiece with a laser beam of a laser is proposed, wherein a laser beam is provided by a laser, the polarization of the laser beam is switched and/or rotated between two polarization states by a polarization switch, the laser beam is split into two partial laser beams by a polarization beam splitter, the two partial laser beams having mutually orthogonal polarizations, the first partial laser beam with the first polarization having a first offset after passing through the polarization beam splitter and the second partial laser beam of a second polarization having a second offset after passing through the polarization beam splitter, and the two partial laser beams are introduced by processing optics into two focal zones in the workpiece, so that the workpiece is processed. According to embodiments of the invention, the intensities of the two partial laser beams are alternately maximized by the switching and/or rotation of the polarization by the polarization switch.

Preferred exemplary embodiments will be described below with the aid of the figures. Elements which are the same or similar, or which have the same effect, are provided with identical reference signs in the various figures, and a repeated description of these elements is sometimes omitted in order to avoid redundancies.

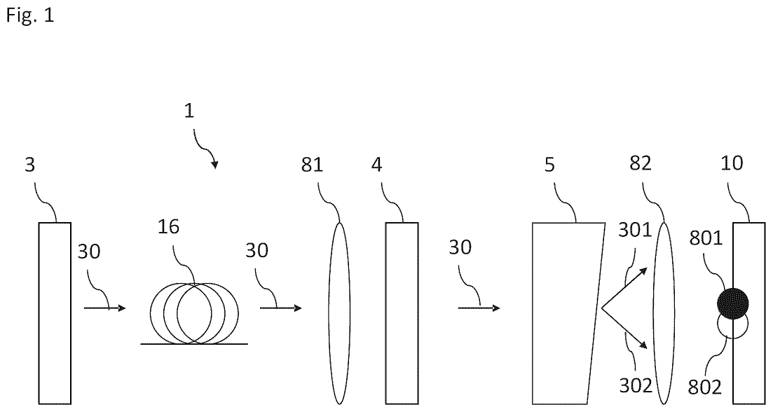

FIG. 1 schematically shows a proposed device 1.

The device 1 has a laser 3, which provides a laser beam 30. The laser beam 30 is guided by fiber guiding 16 to the processing optics 8, which comprise a collimation lens 81 and a focusing lens 82. The processing optics 8 likewise comprise a polarization switch 4, which is suitable for switching and/or rotating the polarization of the laser beam 30. The laser beam 30 with the polarization defined by the polarization switch 4 is subsequently guided to a polarization beam splitter 5, the laser beam 30 being resolved and split into the basis polarization states of the polarization beam splitter 5. The polarization beam splitter 5 in this case generates a first partial laser beam 301, which is polarized according to a first basis polarization state, and a second partial laser beam 302, which is polarized according to a second basis polarization state. The first partial laser beam 301 is subsequently introduced into the workpiece 10 by the focusing lens 82 in a first focal zone 801, and the second partial laser beam 302 is introduced into the workpiece 10 by the focusing lens in the second focal zone 802. The workpiece 10 is processed by the energy which the partial laser beams 301, 302 deposit there.

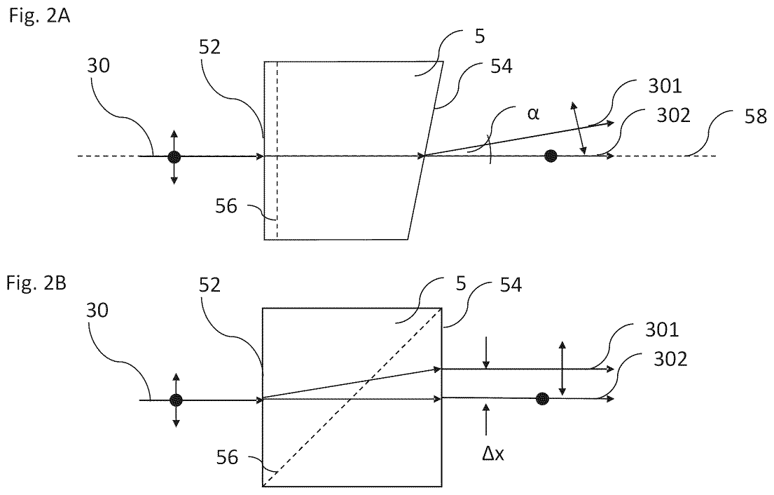

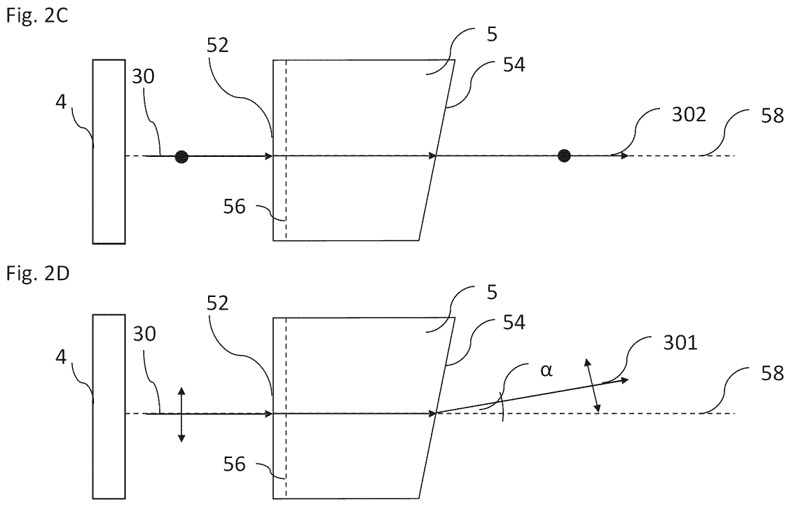

FIGS. 2A, B schematically show two embodiments of a polarization beam splitter 5, with which a laser beam 30 can be resolved into different basis polarization components. The polarization beam splitters 5 are in this case birefringent polarization beam splitters 5 and may, for example, be provided in the form of a birefringent crystal. Various birefringent materials may be used as the crystal material for the polarization beam splitter 5, for example alpha-BBO (alpha barium borate), YVO4 (yttrium vanadate), crystalline quartz, etc.

The polarization beam splitter 5 in FIG. 2A is configured in the shape of a wedge, i.e. a plane beam entry face 52 for entry of an incident laser beam 30 and a plane beam exit face 54 of the polarization beam splitter 5 are aligned at a (wedge) angle with respect to one another. The or an optical axis 56 of the crystal material is aligned parallel to the beam entry face 52.

The laser beam 30 entering the polarization beam splitter 5 perpendicularly to the beam entry face 52 is split at the beam exit face 54, which is inclined at an angle with respect to the beam entry face 52, into two partial laser beams 301, 302 which are polarized perpendicularly to one another, for example respectively s- and p-polarized. In FIG. 2A, as is generally conventional, the s-polarized partial laser beam 302 is denoted by a dot, while the first, p-polarized partial laser beam 301 is denoted by a double arrow. The first, p-polarized partial laser beam 301 is refracted less strongly than the second, s-polarized partial laser beam 302 when emerging from the polarization beam splitter 5, so that an angle offset a occurs between the first and second partial laser beams 300. The first and second partial laser beams 300 in this case emerge from the polarization beam splitter 5 at the same location on the beam exit face 54, that is to say although an angle offset a is generated, a position offset is not generated between the two partial laser beams 300.

In the polarization beam splitter 5 shown in FIG. 2B, the beam entry face 52 and the beam exit face 54 are aligned parallel to one another and the optical axis 56 of the crystal material is aligned at an angle of 45° with respect to the beam entry face 52. The laser beam 30 incident perpendicularly to the beam entry face 52 is in this case split at the beam entry face 52 into a first, ordinary partial laser beam 301 and a second, extraordinary partial laser beam 302. The two partial laser beams 301, 302 emerge parallel at the beam exit face 54, that is to say without an angle offset but with a position offset Δx.

The two polarization beam splitters 5 represented in FIGS. 2A, B therefore differ essentially in that the polarization beam splitter 5 shown in FIG. 2A generates an angle offset a (without a position offset) and in that the polarization beam splitter 5 shown in FIG. 2B generates a position offset Δx (without an angular offset).

FIGS. 2C, D show the interaction with an upstream polarization switch 4, with the assumption that the laser beam 30 which strikes the polarization switch is already or has already been linearly polarized. The polarization switch 4 imparts a defined polarization to the laser beam 30. If the polarization of the laser beam 30 corresponds to one of the basis polarization states of the polarization beam splitter 5, the entire energy of the laser beam 30 is directed along the path of the respective partial laser beam 301, 302 into the corresponding focal zone 801, 802.

For example, FIG. 2C shows that the polarization switch 4 converts the laser beam 30 into an s-polarization state. The s-polarization state is one of the basis polarization states of the polarization beam splitter 5. Accordingly the laser beam 30 is deviated onto the path of the partial laser beam 302. In particular, the s-polarized laser beam 30 contains no p-polarized beam components, so that splitting into two partial laser beams 301, 302 does not take place and only one laser beam 30 (the aforementioned partial laser beam 302) emerges from the polarization beam splitter 5.

FIG. 2D represents the same polarization beam splitter 5 when a p-polarized laser beam 30 is provided by the polarization switch 4. The p-polarization state is also a basis polarization state of the polarization beam splitter 5, so that the energy transport takes place along the path of the partial laser beam 301. The laser beam 30 is in this case deviated by an angle α in relation to the optical axis of the device 58.

It is therefore clear overall from a comparison of FIGS. 2C, D that, in the case of a polarization beam splitter 5 having two basis polarization states s and p, a p-polarized laser beam 30 is deviated and an s-polarized laser beam 30 is not deviated. Accordingly, the deviation for the two polarization states of the laser beam 30 is in general different.

In particular, it is also already known from FIGS. 2A, B that a laser beam having a polarization state which is not a basis polarization state is split into the two basis polarization states and the energy of the laser beam 30 is divided between the two partial laser beams 301, 302.

It is therefore also evident that, in the case of an alternating switched polarization of the laser beam 30 or a rotation of the polarization of the laser beam 30 as a function of time, the path along which the energy of the laser beam 30 is preferably transported also changes.

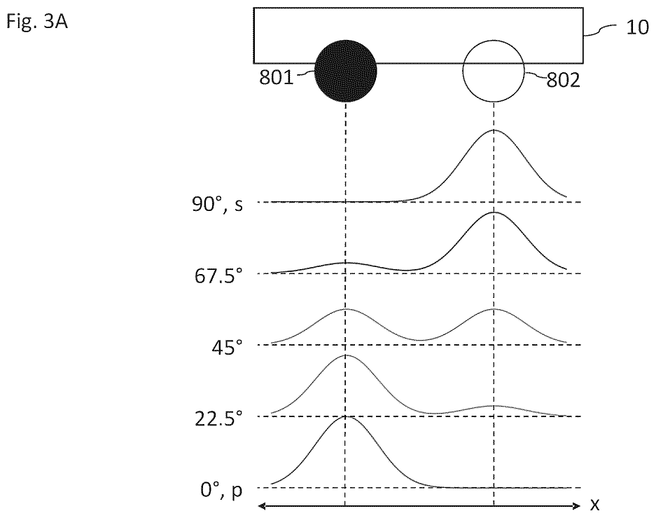

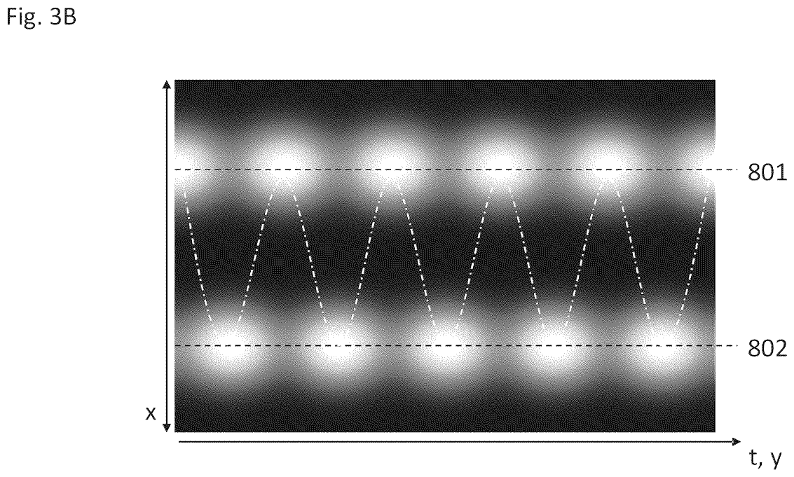

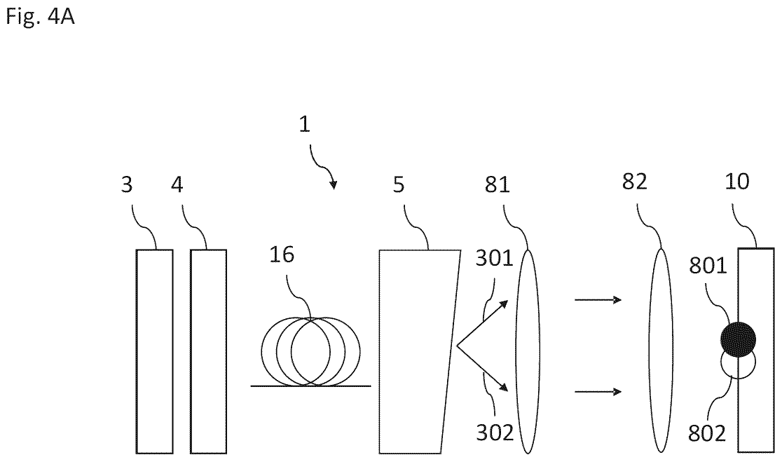

FIG. 3A shows a corresponding time profile of such a polarization change, as well as the associated intensity of the laser beam 30, or of the partial laser beams 301, 302 in the focal zones 801 and 802.

At the start of the time profile, the laser beam 30 may have a polarization of 0° because of a polarization switch, so that the entire laser beam 30 is directed along the path of the partial laser beam 301 into the focal zone 801. With a subsequent 22.5° polarization, the laser beam 30 is resolved by the polarization beam splitter 5 into the corresponding basis polarization states and partial laser beams 301 and 302. The intensity in the focal zone 801 is therefore significantly greater than the intensity in the focal zone 802. With a 45° polarization of the laser beam 30, the intensity is equal in the two focal zones 801 and 802. With a 67.5° polarization of the laser beam 30, the intensity in the focal zone 802 is greater than in the focal zone 801. With a 90° polarization of the laser beam, the polarization of the laser beam 30 again coincides with a basis polarization state of the polarization beam splitter 5, so that the entire energy of the laser beam 30 is transported into the focal zone 802 of the second partial laser beam 302.

In the time profile, a variation of the polarization has therefore brought about a change of the point of incidence of the laser beam 30 in the workpiece 10. A wobble movement of the laser beam 30 may therefore be imitated by a periodic polarization change of the laser beam 30.

FIG. 3B shows a further representation of the wobble movement. For this purpose, a Gaussian laser beam 30 was simulated, the polarization of which is modulated sinusoidally and splitting therefore takes place along the x axis, a feed simultaneously taking place along the y axis. The averaged laser intensity is represented. A low intensity is in this case represented in black and a high intensity in white. It may be seen clearly that the laser intensity introduced into the workpiece 10 alternates back and forth between the focal zones 801, 802 so that the laser beam 30 performs a wobble movement on the workpiece 10, which is additionally illustrated by the white dashed line.

A polarization switch 4 may in this case be a rotating 24 plate or a λ/2 plate, or a voltage-controlled Pockels cell. A rotation of the polarization of the laser beam may be produced simply by means of the rotating wave plates, whereas switching of the polarization may be produced simply by means of the Pockels cell. It is, however, also possible to rotate the polarization continuously with the Pockels cell by applying a periodic voltage.

Furthermore, it is also possible to carry out switching of the polarization by means of segmented wave plates. A first segment of the wave plate may in this case have a birefringent crystal with a first optical axis, and a second segment may have a birefringent crystal with a second optical axis. If, in the case of a rotating segmented wave plate, the laser beam passes through the first crystal, the polarization experiences a first rotation, whereas the laser beam 30 experiences a second polarization rotation if it passes through the second crystal. Switching of the polarization of the laser beam 30 may thus be produced by the rotation of the wave plate.

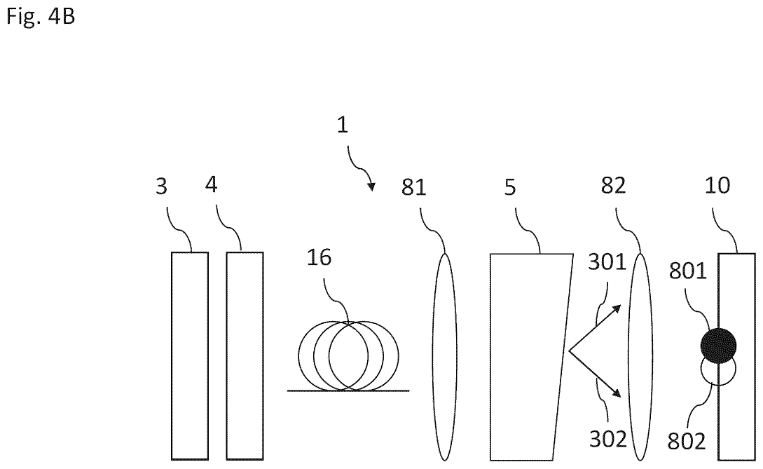

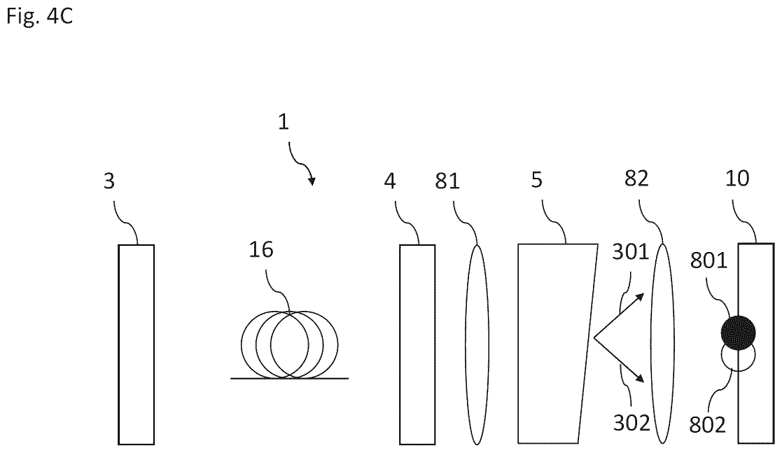

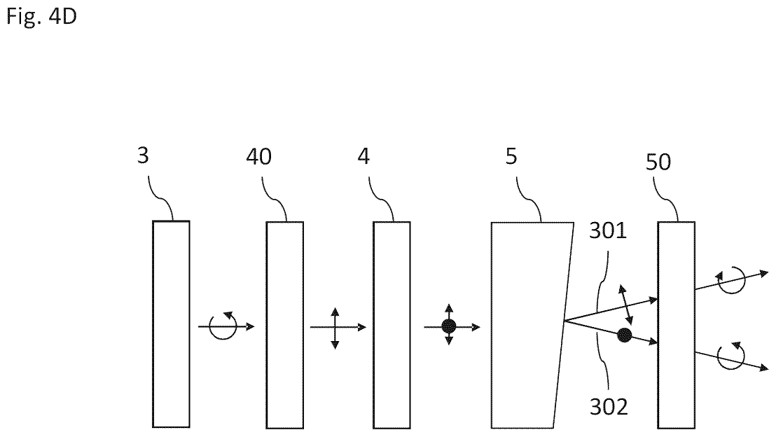

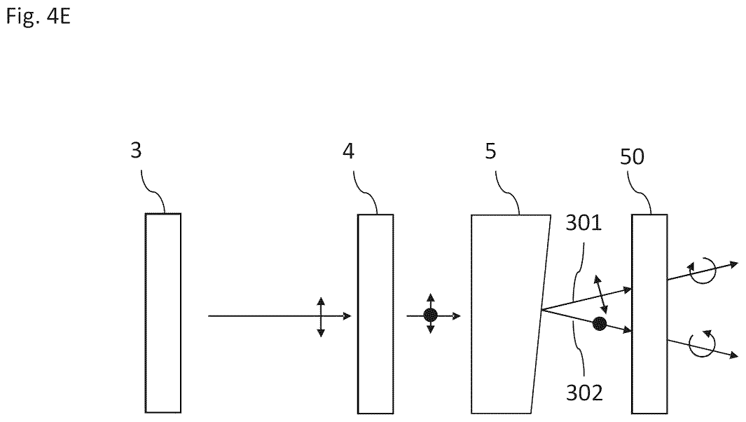

Further alternative embodiments of the device are shown in FIGS. 4A to 4E.

In FIG. 4A, the laser beam 30 of the laser 3 is guided through the polarization switch 4 before it is introduced by fiber guiding 16 and a downstream polarization beam splitter 5 through the processing optics 81, 82 into the workpiece 10.

In FIG. 4B, the laser beam 30 of the laser is guided through the polarization switch 4 before it is collimated by fiber guiding 16 through the collimation lens 81 of the processing optics 8. The polarization beam splitter 5 is arranged between the collimation lens 81 and the focusing lens 82, the focusing lens 82 introducing the partial laser beams 301 and 302 into the workpiece 10 in the focal zones 801, 802 after the polarization beam splitter 5.

In FIG. 4C, the laser beam 30 of the laser is guided by fiber guiding 16 to the polarization switch 4. The laser beam 30 is subsequently collimated by the collimation lens 81 of the processing optics 8 and sent through the polarization beam splitter 5, which splits the laser beam 30 into two partial laser beams 301, 302. The partial laser beams 301, 302 are finally introduced into the workpiece in the focal zones 801, 802 by the focusing lens 82.

In all of FIGS. 4A to 4C, it has been assumed that the laser beam 30 is linearly polarized when it strikes the polarization beam splitter 5. This may, for example, be achieved as in FIGS. 4D and E. In FIG. 4E, the laser beam 30 of the laser 3 is circularly polarized. The circular polarization may be converted into a linear polarization by a λ/4 plate 40. In FIG. 4E, conversely, the laser beam 30 of the laser 3 already has a linear polarization. It is represented in both FIGS. 4D and 4E that the linear basis polarization states of the polarization beam splitter 5 may be converted into circular polarizations by a subsequent λ/4 plate 50.

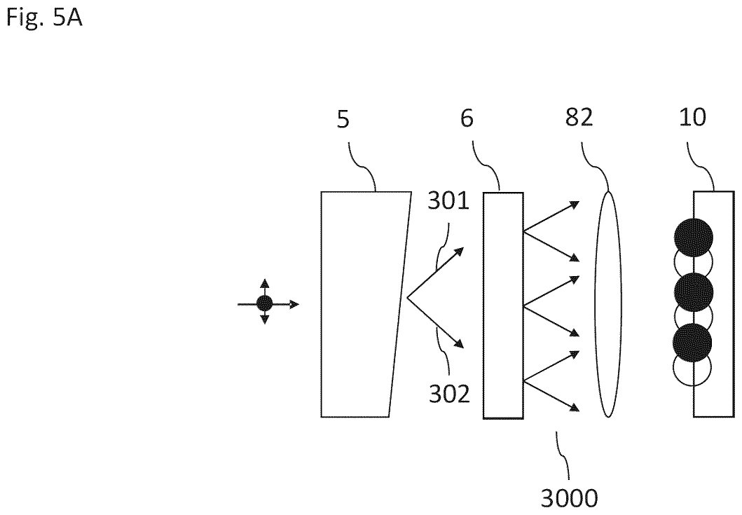

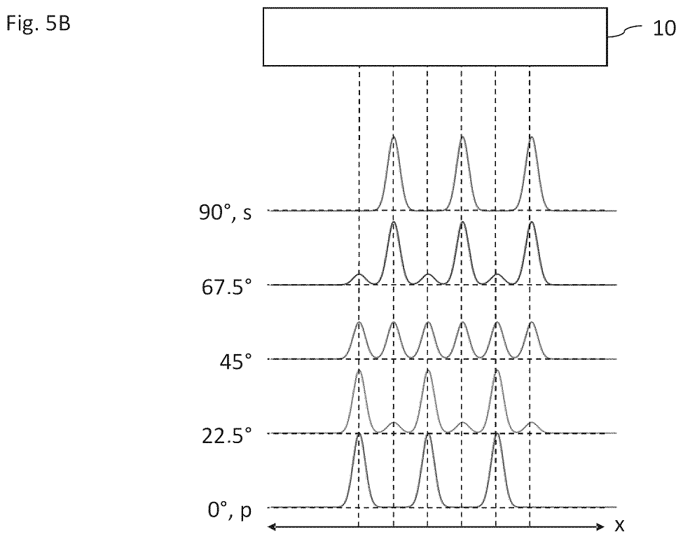

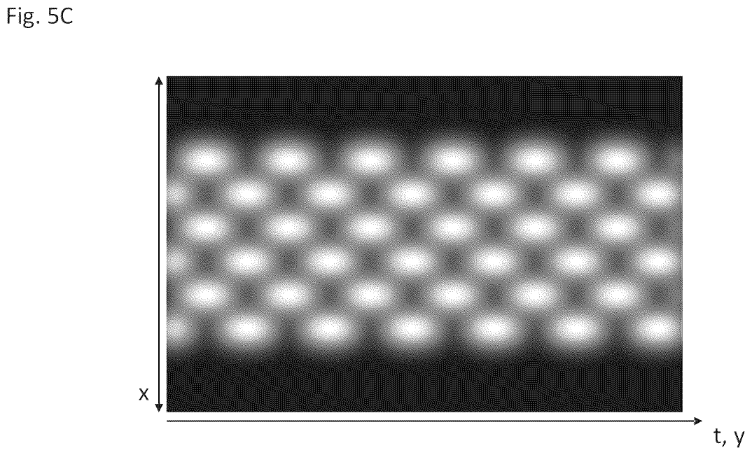

FIG. 5A shows the functionality of beamforming optics 6. Beamforming optics 6 are in this case arranged behind the polarization beam splitter 5. The beamforming optics 6 can in this case resolve the two partial laser beams 301, 302 into a multiplicity of partial laser beams 3000, so that the laser energy can be introduced into the workpiece in a multiplicity of focal zones. The intensity of the partial laser beams 3000, which come from a partial laser beam 301, 302 having a particular basis polarization, may be modified by an upstream polarization switch 4. This is shown in FIG. 5B.

In FIG. 5B, similarly to in FIG. 3A, the intensity of the individual partial laser beams 3000 is modified by the polarization switch 4. As a function of time, a wobble movement may therefore also be produced with a multiplicity of partial laser beams 3000. This is represented for the multi-spot profile in FIG. 5C, in a similar way to FIG. 3B.

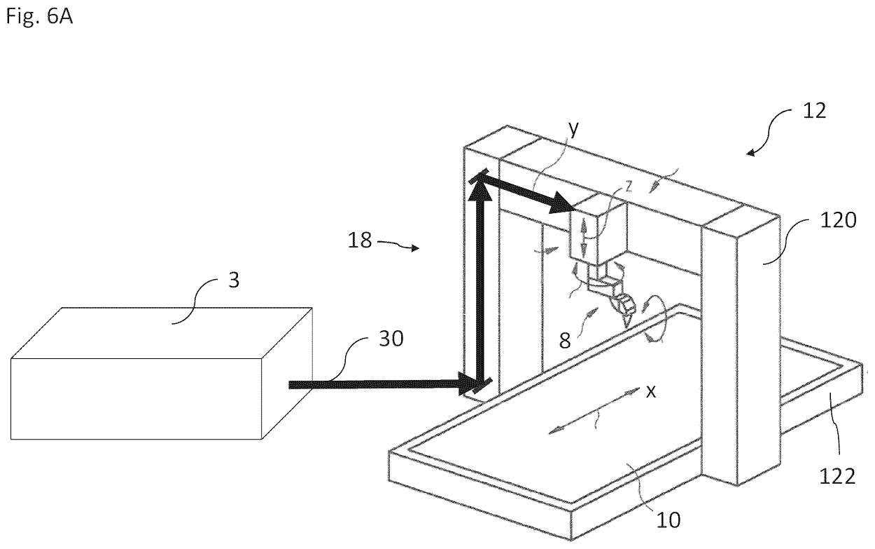

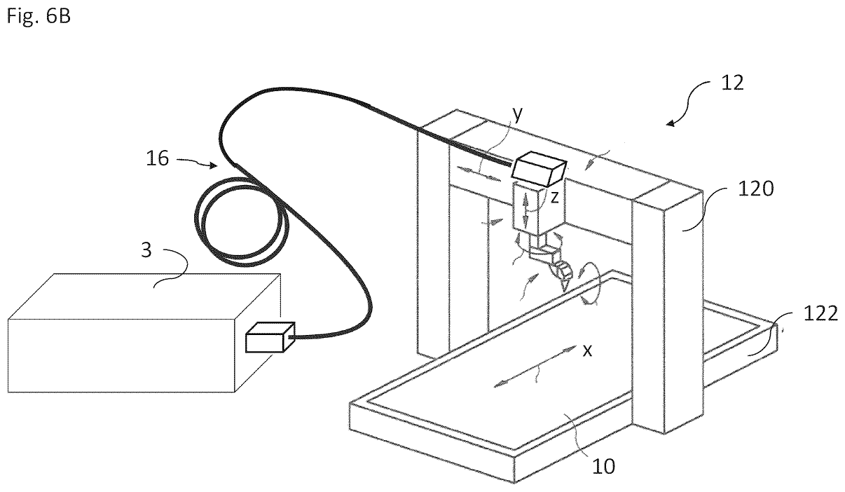

In FIG. 6A, a feed device 12 which is adapted to move the processing optics 8 and the workpiece 10 in translation along three spatial axes XYZ is. The laser beam 30 of the laser 3 is directed onto the workpiece 10 by deviating optics. The workpiece 10 is in this case arranged on a bearing face of the feed device 12, the bearing face preferably neither reflecting nor absorbing nor strongly scattering back into the workpiece 10 the laser energy which the workpiece does not absorb.

In particular, the laser beam 30 may be coupled into the processing optics 8 by free-beam guiding 18. The free-beam guiding 18 may in this case be a free-space section having a lens and mirror system, as shown in FIG. 6A. The beam guiding may, however, also be carried out by means of fiber guiding 16, in particular by means of a hollow-core fiber having input and output optics, as shown in FIG. 6B.

In the present case of FIG. 6A, the laser beam 30 is directed towards the workpiece 10 by a mirror assembly and introduced into the workpiece 10 by the processing optics 8, so that the workpiece 10 is processed. The processing optics 8 may be moved and adjusted relative to the workpiece 10 by the feed device 12.

The feed device 12 can move the workpiece 10 under the laser beam 30 with a feed V, so that the laser beam 30 processes the workpiece 10 along the desired trajectory. In particular, in FIG. 6A as shown, the feed device 6 comprises a first axle system 120 with which the workpiece 10 can be moved along the XYZ axes and optionally rotated. In particular, the feed device 12 may also have a workpiece holder 122 which is adapted to hold the workpiece 10.

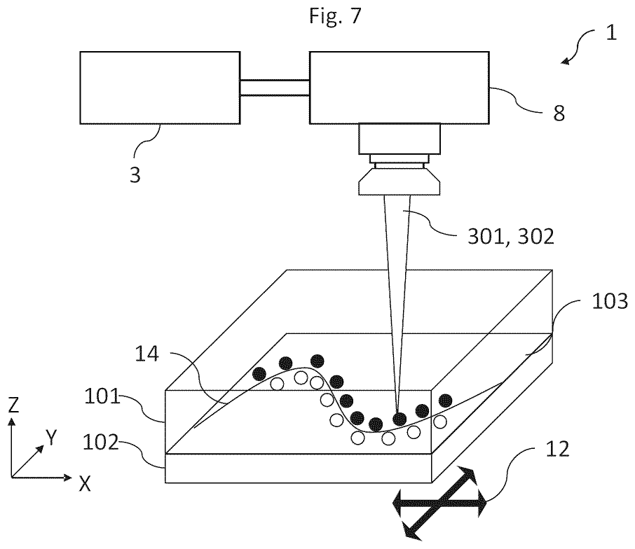

FIG. 7 schematically represents a further device according to embodiments of the invention, which is suitable for joining two joining partners of the workpiece 10. The joining partners 101, 102 are in this case arranged bearing on one another at a common interface 103.

A laser 3 in this case provides, for example, ultrashort laser pulses. These may be introduced into the joining partners 101, 102 in the form of a sequence of individual pulses or in the form of a sequence of bursts.

The average power of the laser spot may in this case be between 0.1 W and 50 W. The laser pulses of a burst may respectively have a temporal spacing of at most 1 μs, preferably between 0.05 ns and 1000 ns, preferably between 20 ns and 80 ns from one another, a burst comprising between 2 and 64 burst pulses, preferably between 2 and 16 burst pulses. The repetition frequency of the individual laser pulses and/or of the bursts may be between 0.5 kHz and 10 MHz, preferably between 1 kHz and 4 MHz. The laser wavelength may be between 200 nm and 5000 nm, preferably 1000 nm, and/or the pulse duration of the laser pulses may be between 10 fs and 50 ps.

In the present case, the laser 3 contains the polarization switch, and the processing optics 8 comprise the polarization beam splitter 5. The processing optics 8 focus the partial laser beams 301, 302 which are generated, in such a way that the focal zones 801, 802 approximately coincide with the common interface 103 of the two joining partners 101, 101.

In order to focus the partial laser beams 301, 302 into the common interface 103 of the joining partners 101, 102, the first joining partner 101 in the beam propagation direction needs to be transparent for the wavelength of the laser 3. For example, the first joining partner 101 may be a glass, a crystal, a ceramic or a plastic. For example, the second joining partner 102 may be opaque or transparent. For example, the second joining partner 102 may be a metal, a semiconductor, a plastic or a ceramic.

At the interface 103, successive laser pulses are absorbed in the focal zones 801, 802 in such a way that the material of the joining partners 101, 102 melts and is connected across the interface 103 to the other respective joining partner 102, 101. As soon as the melt cools, a permanent connection of the two joining partners 101, 102 is formed. In other words, the two joining partners 101, 102 are joined together in this region by welding. This region, in which the melting and connection of the materials as well as the subsequent cooling of the melt occur and in which the actual joining correspondingly takes place, is also referred to as the joint. The cooled melt and material bonding of the joining partners 101, 102 forms a weld seam.

The laser beam and the joining partners may be moved and/or positioned relative to one another with a feed V of between 0.01 mm/s and 1000 mm/s, preferably between 0.1 mm/s and 300 mm/s. For this purpose, the joining partners may for example be positioned on a feed device 12, as already explained above. In this way, it is possible for the partial laser beams 301, 302 to be displaced along a joining seam over the joining partners 101, 102, so that the joining partners 101, 102 can be joined along the joining seam.

When the joining partners 101, 102 are being joined with a wobble movement superimposed by the polarization switch 4, a melt zone is to a certain extent generated periodically to the left and right of the joining trajectory 14. It is, however, also possible for the melt zones to be generated above and below the trajectory 14, that is to say a first melt zone is generated in the first joining partner and a second melt zone is generated in the second joining partner. By the spatial alternation of the location of the introduction of energy, a larger melt volume may be generated with the same average power of the laser. This leads overall to a higher quality of the joining seam in the form of more stable weld seams, less crack formation due to material stresses, less visibility of the joining seams and an increased hermeticity.

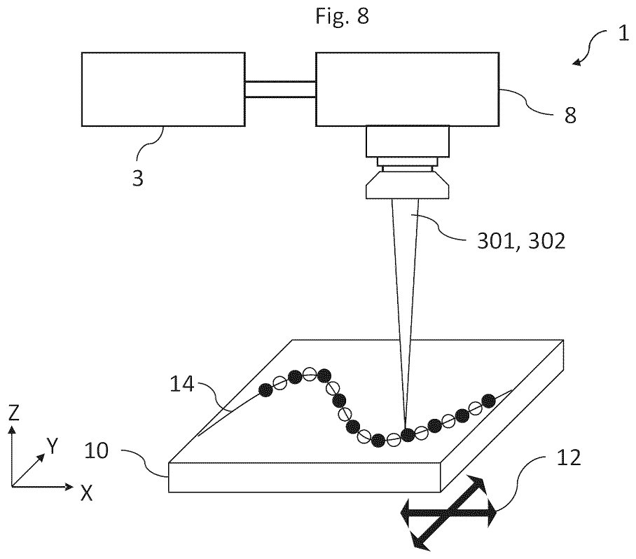

FIG. 8 schematically shows a further device according to embodiments of the invention, which is suitable for separating a workpiece 10, in particular for sheet-metal cutting. In this case, in a similar way to FIG. 7, the partial laser beams 301, 302 are introduced along a trajectory 14 along which the material is intended to be separated.

The focal zones 801, 802 may in this case lie on the trajectory, so that a higher cutting rate, or higher process speed, may be achieved together with an increase in the cutting quality. It is, however, also possible for the focal zones 801, 802 to be introduced next to the actual trajectory, in a similar way to FIG. 7.

Insofar as applicable, all individual features presented in the exemplary embodiments may be combined with one another and/or interchanged, without departing from the scope of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 device
10 workpiece
101 first joining partner
102 second joining partner
103 interface
12 feed device
120 axle system
122 workpiece holder
14 trajectory
16 fiber guiding
18 freebeam guiding
3 laser
30 laser beam
301 first partial laser beam
302 second partial laser beam
3000 partial laser beam
4 polarization switch
40 λ/4 plate
5 polarization beam splitter
50 λ/4 plate
52 beam entry face
54 beam exit face
56 optical axis of the birefringent crystal
58 optical axis of the device
6 beamforming optics
8 processing optics
81 collimation lens
82 focusing lens
801 first focal zone
802 second focal zone
α angle offset between the partial laser beams
Δx position offset between the partial laser beams
V feed

1. A device for processing a workpiece with a laser beam, the device comprising a laser configured to emit the laser beam,
a polarization switch configured to switch the polarization of the laser beam between two polarization states and/or to rotate the polarization of the laser beam,
a polarization beam splitter configured to split the laser beam into a first partial laser beam and a second partial laser beam, the first partial laser beam having a first polarization state, the second partial laser beam having a second polarization state orthogonal to the first polarization state, the first partial laser beam having a first offset after passing through the polarization beam splitter, and the second partial laser beam having a second offset after passing through the polarization beam splitter, and
processing optics configured to introduce the first partial laser beam into the workpiece in a first focal zone and the second partial laser beam into the workpiece in a second focal zone, in order to process the workpiece,
wherein
the polarization switch is arranged before the polarization beam splitter in a beam propagation direction, the switching and/or the rotation of the polarization by the polarization switch alternately maximize intensities of the first partial laser beam and the second partial laser beam.

2. The device according to claim 1, wherein the polarization beam splitter is configured as a birefringent polarizing beam splitter in a form of a birefringent crystal.

3. The device according to claim 1, wherein a wavelength of the laser beam is between 200 nm and 2000 nm.

4. The device according to claim 1, wherein the laser is a continuous-wave laser or a pulsed laser, and is a single-mode laser or a multimode laser, and is a fiber-guided laser or a free-space-guided laser.

5. The device according to claim 1, a degree of polarization of the laser beam before the polarization switch is more than 50%.

6. The device according to claim 1, wherein the laser comprises the polarization switch.

7. The device according to claim 1, wherein the polarization switch is a Pockels cell, and/or a rotating 24 plate, and/or a rotating λ/2 plate.

8. The device according to claim 1, wherein the polarization beam splitter is configured to spatially split the laser beam into the first partial laser beam and the second partial laser beam having an angle offset and/or a position offset with respect to one another after passing through the polarization beam splitter, wherein the first polarization state and the second polarization state are two mutually orthogonal linear polarization states.

9. The device according to claim 1, further comprising a λ/4 plate arranged before the polarization beam splitter in the beam propagation direction and configured to convert a circularly polarized laser beam into a linearly polarized laser beam.

10. The device according to claim 1, wherein the first polarization state and the second polarization state are two mutually orthogonal linear polarization states, behind the polarization beam splitter in the beam propagation direction.

11. The device according to claim 10, further comprising a λ/4 plate arranged behind the polarization beam splitter in the beam propagation direction and configured to convert the two mutually orthogonal linear polarization states into two mutually orthogonal circular polarization states.

12. The device according to claim 1, wherein the processing optics comprise a collimation lens and a focussing lens.

13. The device according to claim 1, wherein the processing optics comprise a beamforming element, configured to convert a first intensity distribution of the laser beam into a second intensity distribution of the laser beam.

14. The device according to claim 13, wherein the beamforming element is configured to impart a Gaussian beam profile, or a nondiffractive beam profile, or a flat-top beam profile to the laser beam.

15. The device according to claim 13, wherein the second intensity distribution is a multi-spot distribution, each individual spot of the multi-spot distribution having a Gaussian beam profile, or a nondiffractive beam profile, or a flat-top beam profile.

16. The device according to claim 1, wherein the workpiece is separated by the processing along a separating line, or the workpiece comprises two parts that are joined together by the processing.

17. Device according to claim 1, further comprising a feed device configured to move the workpiece and the laser beam relative to one another with a feed along a trajectory.

18. The device according to claim 1, further comprising a scanner unit configured to scan the laser field over the workpiece.

19. The device according to claim 1, wherein
the polarization switch is arranged before or after fiber guiding or free-space guiding, and/or before or after a collimation lens, and
the polarization beam splitter is arranged after the collimation lens and after the polarization switch and before focusing optics or before the collimation lens and after the polarization switch.

20. A method for processing a workpiece with a laser beam, the method comprising:
providing a laser beam using a laser,
switching a polarization of the laser beam and/or rotating the polarization of the laser beam between two polarization states using a polarization switch,
splitting the laser beam into a first partial laser beam and a second partial laser beam using a beam splitter, the first partial laser beam having a first polarization state and a first offset after passing through the polarization beam splitter, and the second partial laser beam having a second polarization state orthogonal to the first polarization state a second offset after passing through the polarization beam splitter, and
introducing, using processing optics, the first partial laser beam and the second partial laser beam into two focal zones in the workpiece, so that the workpiece is processed,
wherein
the intensities of the first partial laser beam and the second partial laser beam are alternately maximized by the switching and/or the rotation of the polarization by the polarization switch.
